(19) United States
(12) Patent Application Publication
(10) Pub. No.: US 2023/0141829 A1
(43) Pub. Date: May 11, 2023

(54) HEATING/COOLING SYSTEM FOR A VEHICLE, IN PARTICULAR FOR AN ELECTRIC OR HYBRID VEHICLE, HOLDING ELEMENT FOR SUCH A HEATING/COOLING SYSTEM

(71) Applicant: OET GMBH, Lustenau (AT)

(72) Inventors: Christian BUSCH, Feldkirch (AT); Christian SCHMÄLZLE, Lauterach (AT); Frank OBRIST, Bregenz (AT); Philipp STEGMÜLLER, Wiesloch (AT)

(21) Appl. No.: 17/907,508

(22) PCT Filed: Mar. 24, 2021
(86) PCT No.: PCT/EP2021/057571

§ 371 Date: Sep. 27, 2022

(30) Foreign Application Priority Data
Apr. 1, 2020 (DE) 10 2020 109 006.4

(51) Int. Cl. B60H 1/32; B60H 1/00

(52) U.S. Cl. CPC B60H 1/3229; B60H 1/00571; B60H 2001/3286; B60Y 2200/91

(57) ABSTRACT

The invention relates to a heating/cooling system for a vehicle, in particular for an electric or hybrid vehicle, comprising components, in particular a compressor (10), a condenser (11), and expansion device (12), and an evaporator (13) which are fluidically connected together in order to form a fluid circuit. The invention is characterized by a holding element (14) with a wall structure (15) which has at least one through-opening (16). At least two components are arranged on opposite sides of the wall structure (15) and are mechanically connected to the wall structure (15), wherein the two components are directly fluidically connected together by the through-opening (16) in order to form a fluid passage. The invention additionally relates to a holding element for such a heating/cooling system.

The invention relates to a heating/cooling system for a vehicle according to the preamble of claim 1. The invention further relates to a holding element for such a heating/cooling system.

A heating/cooling system of the kind mentioned at the outset is known from practice. Such heating/cooling systems are used for vehicles, for example to operate a vehicle air conditioning system. The main components of such a heating/cooling system are usually a compressor, a condenser, an expansion device, and an evaporator. These components are often arranged distributed in the vehicle, and connected with each other by lines, in particular pipes that carry coolant. Alternatively known is to mount at least some of these components together on a holding plate. However, the fluid connection established by means of lines remains intact in the previously known heating/cooling systems.

The distributed arrangement of the individual components increases the complexity of the known heating/cooling systems, in particular with respect to assembly. The fluid lines that connect the components must often be individually adjusted during the assembly of the heating/cooling system in different vehicles. In addition, in particular the fluid lines increase the installation space required by the heating/cooling systems previously known from practice.

In this regard, the object of the present invention is to propose a heating/cooling system that has a simple structure and a compact design. It is further the object of the invention to indicate a holding element for such a heating/cooling system.

According to the invention, this object is achieved with respect to the heating/cooling system by the subject matter of claim 1, and with respect to the holding element by the subject matter of claim 10.

In particular, the invention is based on the idea of indicating a cooling system for a vehicle, in particular for an electric or hybrid vehicle, with components that are fluidically connected with each other to form a fluid circuit. For example, such components can be a compressor, a condenser, an expansion device, and an evaporator. According to the invention, the heating/cooling system has a holding element with a wall structure which has at least one through opening. At least two components of the heating/cooling system are arranged on opposite sides of the wall structure and mechanically connected with the wall structure. The two components are here directly fluidically connected with each other by the through opening to form a fluid passage.

As a consequence, the holding element provided in the invention performs a dual function. On the one hand, it mechanically holds and connects the at least two components. In this regard, the holding element forms a mechanical holder for the heating/cooling system. On the other hand, the holding element also produces the fluid connection between the at least two components by means of the through opening. Additional lines for fluidically connecting the individual components are thus not necessary. As a whole, then, this yields an especially compact heating/cooling system, which additionally has an especially simple structure.

In a preferred embodiment of the heating/cooling system according to the invention, the wall structure has several through openings. The wall structure can be mechanically connected with several components. Components arranged on opposite sides of the wall structure are preferably directly fluidically connected with each other by the through openings in such a way that the wall structure, the through openings and the components form a fluid circuit.

Specifically, all fluid connections of the heating/cooling system can be formed by means of the through openings in the wall structure. This contributes to an especially compact design for the heating/cooling system. In addition, this eliminates the need for any additional fluid lines, whether they be rigid pipes, or flexible hoses for connecting the individual components. The compact heating/cooling system thus also has a very simple structure.

The wall structure can specifically have a first through opening and a second through opening.

The first through opening can form a direct fluid connection between the compressor and the condenser.

The second through opening can be provided to form a direct fluid connection between the condenser and the expansion device.

In addition, the wall structure can have a third through opening, which forms a direct fluid connection between the expansion device and the evaporator.

A fourth through opening can likewise be provided, wherein the fourth through opening forms a direct fluid connection between the evaporator and the compressor.

The components essential for operating the heating/cooling system are in this way coupled via fluid connections, which are provided completely by the holding element. Therefore, the holding element forms not only a mechanical connection of the individual components, but also a fluid connection. Coolants can in this way circulate on short paths between the components.

The wall structure preferably has a first side and a second side. It can here be provided that the compressor and the expansion device be arranged on the first side of the wall structure, and be mechanically connected with the wall structure.

The condenser and the evaporator can be arranged on the second side of the wall structure, and mechanically connected with the wall structure. In particular, the condenser and the evaporator can be arranged next to each other on the second side of the wall structure. The condenser and the evaporator here together preferably assume a length that essentially does not exceed the length of the compressor. In this regard, then, arranging the compressor and expansion device on the first side of the wall structure and the condenser and evaporator on the second side of the wall structure enables an especially compact shape for the heating/cooling system.

In a preferred embodiment, the holding element is T-shaped in design, wherein the wall structure is arranged perpendicular to a floor structure. The floor structure can essentially form a fastening plate for fastening the heating/cooling system in a vehicle.

In particular, the floor structure can have a first floor part and a second floor part, wherein the first floor part is larger in design than the second floor part. The first floor part preferably abuts against the first side, and the second floor part against the second side of the wall structure. The relatively larger first floor part is thus also arranged on the first side of the wall structure on which the relatively heavy and comparatively large compressor is also arranged.

In this regard, the first floor part forms a larger footprint or fastening surface than the second floor part, so that the heating/cooling system has a good stability. The weight of the individual components is in this way uniformly entered into the floor structure via the holding element. The floor structure can then introduce these forces just as uniformly into load-bearing elements of a vehicle.

The wall structure by the holding element preferably has recesses that are arranged between the through openings. In particular, these recesses can cause a reduction in weight. This not only improves the compactness of the heating/cooling system, but in particular also reduces its weight, which is especially relevant in modern vehicles, in particular electric vehicles, so as to expand the range or reduce energy consumption.

A secondary aspect of the invention relates to a holding element for a heating/cooling system described above. The holding element according to the invention preferably has a wall structure that comprises at least four through openings and several mechanical connecting means, so that a compressor, a condenser, an expansion device and an evaporator can be fluidly connected by the through opening to form a fluid circuit and mechanically connected with the wall structure via the connecting means.

The advantages and preferred further developments mentioned above in conjunction with the heating/cooling system here also apply analogously for the holding element secondarily claimed here. Specifically, the holding element combines the function of the mechanical holder for the individual components with the function of the fluid connection between the individual components. This creates an especially compact heating/cooling system.

The invention will be explained in more detail below based on exemplary embodiments. Shown therein are:

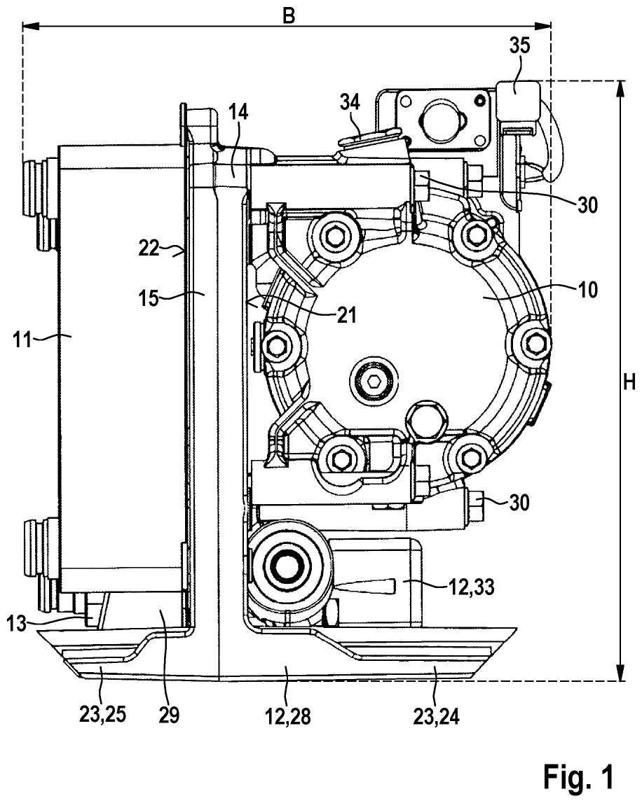

FIG. 1 a front view of a heating/cooling system according to the invention based on a preferred exemplary embodiment;

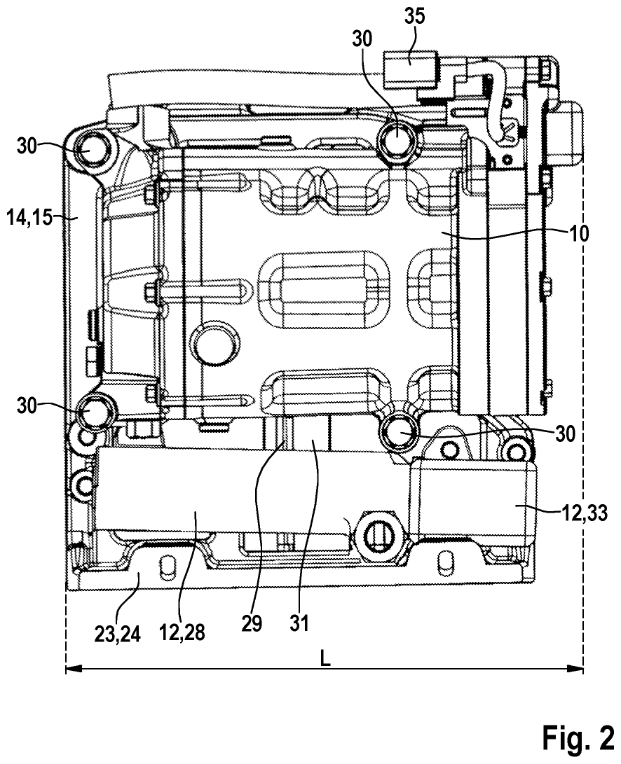

FIG. 2 a side view of the heating/cooling system according to FIG. 1;

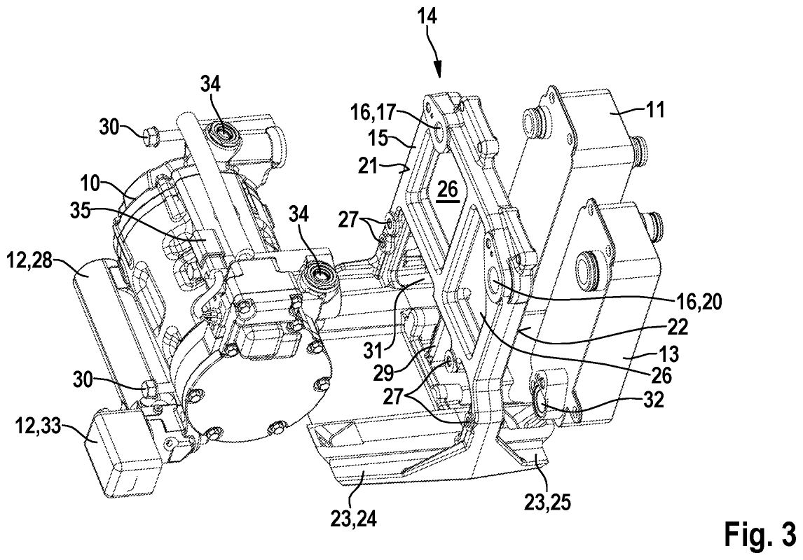

FIG. 3 an exploded view of the heating/cooling system according to FIG. 1;

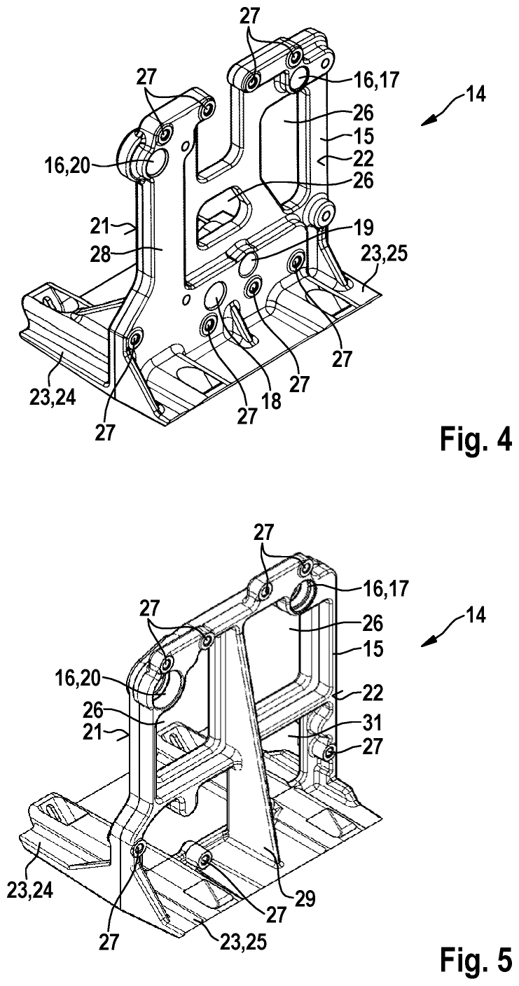

FIG. 4 a perspective view of a holding element for a heating/cooling system according to the invention based on a preferred exemplary embodiment; and

FIG. 5 a perspective view of a holding element according to the invention for the heating/cooling system according to FIG. 1.

FIG. 1 shows a front view of a preferred exemplary embodiment of the heating/cooling system with an especially compact and simple design.

In general, the heating/cooling system comprises several components. Specifically, the heating/cooling system has a compressor 10, a condenser 11, an expansion device 12 and an evaporator 13. These components are mechanically connected with each other by means of a holding element 14.

The holding element 14 has a wall structure, which is designed as once piece with a floor structure 23. In the front view according to FIG. 1, the floor structure 23 and the wall structure 15 essentially form a T-shaped cross sectional profile.

The floor structure 23 comprises a first floor part 24 and a second floor part 25. The first floor part 24 is larger than the second floor part 25. Specifically discernible is that the first floor part 24 has a width that is larger than the width of the second floor part 25.

The first floor part 24 proceeds from a first side 21 of the wall structure 15 of the holding element 14. The compressor 10 is fastened to the first side 21. Additionally provided is an expansion device 12, which is likewise mechanically connected with the holding element 14, preferably the wall structure 15.

The holding element 14 has several connecting means 27 for the mechanical connection (FIG. 4, 5). The mechanical connecting means 27 are preferably designed as threaded holes in the wall structure 15. The individual components, in particular the compressor 10 with the holding element 14, are connected via screws 30 or threaded bolts.

The expansion device 12 is arranged below the compressor 10, specifically between the first floor part 24 and the compressor 10. The expansion device 12 can likewise be connected with the holding element 14 by means of screws 30.

As further discernible on FIG. 1, the wall structure 15 has two additional components on a second side 22. Specifically, a condenser 11 and an evaporator 13 are fastened on the second side 22 of the wall structure 15.

In general, the components of the heating/cooling system are not just mechanically connected with the holding element 14, but rather additionally also fluidically connected by means of the holding element 14. It is preferred that the heating/cooling system generally comprise a coolant, which flows in a coolant circuit through the individual components. To this end, the individual components are coupled with each other by fluid connections. In the invention, these fluid connections are at least partially provided by the holding element 14. As discernible on FIGS. 3 to 5, the wall structure to this end has several through openings 16, which produce a fluid connection between the individual components.

As made evident by FIG. 3, which shows an exploded view of the heating/cooling system, the holding element 14 in the wall structure 15 has a first through opening 17, which produces a direct fluid connection between the compressor 10 and the condenser 11. Further provided is a fourth through opening 20, which forms a direct fluid connection between the evaporator 13 and the compressor 10.

The holding element 14 shown on FIG. 3 comprises several recesses 26 for weight reduction. A lower recess 31 is here dimensioned in such a way that a fluid port 32 of the condenser 11 and the evaporator 13 can be fluidically connected directly with the expansion device 12. The fluid ports 32 can thus engage through the lower recess 31, and thereby be coupled directly to the expansion device 12.

In alternative exemplary embodiments of the holding element 14, second and third through openings 18, 19 can also be provided in the wall structure 15, so as to produce the fluid connection between the condenser 11 and the expansion device 12 or between the evaporator 13 and the expansion device 12. FIG. 4 shows an example for such an exemplary embodiment of a holding element 14.

The expansion device 12 generally comprises an expansion valve 33 and a reservoir 28 for coolant. The expansion valve 33 is preferably directly fluidically connected with the evaporator 13 via a fluid port 32 or via a third through opening 19. In the exemplary embodiment according to FIGS. 1 to 3, the expansion valve 33 is directly coupled with a fluid port 32 of the evaporator 13.

As in the exemplary embodiment according to FIGS. 1 to 3, the reservoir 28 can be secured to the holding element 14 as a separate component. Alternatively, the reservoir 28 can also be integrated into the holding element 14. In particular, the holding element 14 can have an inner cavity, which serves as a reservoir 28 for coolant. In both variants, the reservoir 28 is preferably fluidically connected with the condenser 11. Given a separate reservoir 28, the fluid connection can be produced directly via a fluid port 32 or via a second through opening 18 in the holding element 14. A reservoir 28 integrated into the holding element 14 is preferably connected with a second through opening 18.

FIGS. 4 and 5 show two different exemplary embodiments of a holding element 14. In the exemplary embodiment according to FIG. 4, the holding element 14 additionally has an integrated reservoir 28 for coolant. In particular, the reservoir 28 can be integrated into the wall structure 15. In addition, the reservoir 28 can also be integrated into the floor structure 23. In any event, it is provided that the holding element 14 have a cavity for storing coolant. This cavity forms the integrated reservoir 28.

The holding element 14 according to FIG. 4 has a base structure that is preferred for all exemplary embodiments of the invention. In this regard, the holding element 14 comprises a wall structure 15 that stands perpendicularly on a floor structure 23. The floor structure 23 comprises a first floor part 24, which is larger than an oppositely arranged second floor part 25. Recesses 26 are formed in the wall structure 15 for weight reduction purposes. The wall structure further comprises several through openings 16. Specifically, four through openings 17, 18, 19, 20 are provided. At least one of the through openings can have an additional cross connection to the integrated reservoir 28.

In particular, a first through opening 17 is provided, which forms a direct fluid connection between the compressor 10 and the condenser 11. A second through opening 18 formed near the floor structure 23 can form a direct fluid connection between the condenser 11 and an expansion device 12. A third through opening 19 can further be provided for a direct fluid connection between the expansion device 12 and the evaporator 13. The third through opening 19 is likewise formed near the floor structure 23. A fourth through opening 20 arranged at the upper end of the wall structure 15 just like the first through opening 17 is provided to form a direct fluid connection between the evaporator 13 and the compressor 10.

Also evident on FIG. 4 are several connecting means 27 in the form of threaded holes, which make it possible to mechanically attach the individual components to the holding element 14.

The exemplary embodiment of a holding element 14 according to FIG. 5 differs from the holding element according to FIG. 4 in that no integrated reservoir 28 is provided. This holding element 14, which is also used in the exemplary embodiment of the heating/cooling system according to FIG. 1-3, is rather provided for use with a separate reservoir 28.

The holding element 14 according to FIG. 5 has a lower recess 31, so that fluid ports 32 can reach directly through the wall structure 15. Further provided for the stability of the wall structure 15 is a vertical reinforcing rib 29, which is supported below against the second floor part 25 of the floor structure 23. In this regard, the holding element 14 or the wall structure 15 has only the first through opening 17 and the fourth through opening 20, which produce a direct fluid connection between the compressor 10 and the condenser 11 on the one hand, and the evaporator 13 on the other. The direct fluid connection between the expansion device 12 and the condenser 11 or the evaporator 13 takes place directly via the fluid ports 33 that reach through the lower recess 31.

The holding element 14 according to FIG. 5 also has additional recesses 26 that essentially serve weight reduction purposes. Further discernible are connecting means 27 in the form of threaded holes, which are used to fasten the individual components to the holding element 14.

The entire heating/cooling system can have additional components that are discernible on FIG. 3. In particular, electrical connections 34 can be provided on the upper side of the compressor 10. In this regard, it is preferred that the compressor 10 be an electrical compressor, in particular an electrical reciprocating compressor. Finally, a pressure and temperature sensor 35 can also be connected with the compressor 10.

The entire heating/cooling system preferably has an especially compact structure. In particular, by combining the mechanical connection and fluid connection in the single holding element 14, the entire heating/cooling system has especially compact dimensions or takes up very little installation space in a vehicle.

Viewed in a longitudinally axial direction of the compressor 10, the length L of the heating/cooling system according to the invention can specifically measure at most 290 mm, in particular at most 270 mm, preferably about 250 mm. The width B of the heating/cooling system, which is essentially determined perpendicular to the wall structure 15 and along the floor structure 13, preferably measures at most 280 mm, in particular at most 260 mm, in particular about 240 mm.

The height H of the heating/cooling system preferably measured along the wall structure 15 and perpendicular to the floor structure 23 can measure at most 290 mm, in particular at most 270 mm, in particular about 250 mm.

Also advantageous is that doing away with in particular rigid pipes between the individual reduces the mass of the heating/cooling system. In preferred embodiments, the mass of the heating/cooling system measures at most 15 kg, in particular at most 14 kg, in particular at most 13.8 kg, in particular at most 13.7 kg, in particular at most 13.5 kg, in particular at most 13.3 kg, in particular at most 13.2 kg, in particular at most 13.1 kg, in particular at most 13.05 kg, in particular at most 13.02 kg, in particular at most 13.0 kg, in particular at most 12.9 kg, in particular at most 12.8 kg, in particular at most 12.7 kg, in particular at most 12.6 kg, in particular at most 12.5 kg.

Eliminating the tubular or hose-like connections between the individual components also reduces the inner volume of the coolant circuit. As a result, the quantity of required coolant can be greatly reduced. In particular, the heating/cooling system according to the invention is characterized in that it can be operated with at most 160 g, in particular at most 150 g, in particular at most 140 g, in particular at most 130 g of a coolant.

In addition, eliminating the tubular or hose-like connections between the individual components also helps to reduce the danger of leaks. The coolant circuit is limited to a defined area in a vehicle. The heat or cold of the coolant can be transferred to a water circuit via a heat exchanger. In this way, only water lines are guided through the vehicle.

Another advantage offered by the heating/cooling system according to the invention lies in the fact that the heating/cooling system operation can be easily switched from a cooling operation to a heating operation. The heating/cooling system can be used both as a cooling unit for an air conditioning system, and as a heat pump for a heating system. In particular, it is easy to switch between these two operating modes, which makes the heating/cooling system interesting in particular for electrically operated vehicles. The problem in electrically operated vehicles is that, as opposed to internal combustion engines, the drive system does not generate any significant waste heat, which can be used for heating the interior of the vehicle. In this regard, electrically operated heating systems are expedient. The invention offers such an electrically operated heating system, which at higher outdoor temperatures can alternatively also be used as an air conditioning system for cooling the interior.

### REFERENCE LIST

10 Compressor
11 Condenser
12 Expansion device
13 Evaporator
14 Holding element
15 Wall structure
16 Through opening
17 First through opening
18 Second through opening
19 Third through opening
20 Fourth through opening
21 First side
22 Second side
23 Floor structure
24 First floor part
25 Second floor part
26 Recess
27 Connecting means
28 Reservoir
29 Reinforcing rib
30 Screw
31 Lower recess
32 Fluid port
33 Expansion valve
34 Electrical connection
35 Pressure and temperature sensor
L Length
B Width
H Height

1. A heating/cooling system for a vehicle, in particular for an electric or hybrid vehicle, with components, in particular a compressor, a condenser, an expansion device and an evaporator, which are fluidically connected with each other to form a fluid circuit,
wherein
a holding element with a wall structure that has at least one through opening, wherein at least two components are arranged on opposite sides of the wall structure and mechanically connected with the wall structure, wherein the two components are directly fluidically connected with each other by the through opening to form a fluid passage.

2. The heating/cooling system according to claim 1,
wherein
the wall structure has several through openings and is mechanically connected with several components, wherein components arranged on opposite sides of the wall structure are directly fluidically connected with each other by through openings in such a way that the wall structure, the through openings and the components form a fluid circuit.

3. The heating/cooling system according to claim 2,
wherein
the wall structure has a first through opening that forms a direct fluid connection between the compressor and the condenser, a second through opening that forms a direct fluid connection between the condenser and the expansion device, a third through opening that forms a direct fluid connection between the expansion device and the evaporator, and a fourth through opening that forms a direct fluid connection between the evaporator and the compressor.

4. The heating/cooling system according to claim 1,
wherein
the wall structure has a first side and a second side.

5. The heating/cooling system according to claim 4,
wherein
the compressor and the expansion device are arranged on the first side of the wall structure and mechanically connected with the wall structure.

6. The heating/cooling system according to claim 4,
wherein
the condenser and the evaporator are arranged on the second side of the wall structure and mechanically connected with the wall structure.

7. The heating/cooling system according to claim 1,
wherein
the holding element is T-shaped in design, wherein the wall structure is arranged perpendicular to a floor structure.

8. The heating/cooling system according to claim 7,
wherein
the floor structure has a first floor part and a second floor part, wherein the first floor part is larger in design than the second floor part, and the first floor part abuts against the first side and the second floor part against the second side of the wall structure.

9. The heating/cooling system according to claim 1,
wherein
the wall structure has recesses that are arranged between through openings.

10. A holding element for a heating/cooling system according to claim 1,
wherein
the wall structure has at least four through openings and several mechanical connecting means, so that a compressor, a condenser, an expansion device and an evaporator can be fluidly connected by the through openings to form a fluid circuit and mechanically connected with the wall structure via the connecting means.
